(19) United States
(12) Patent Application Publication
(10) Pub. No.: US 2020/0200938 A1
(43) Pub. Date: Jun. 25, 2020

(54) THREE-DIMENSIONAL FORMATION MICROSCANNER TOOL AND LOGGING METHOD USING THE SAME

(71) Applicant: QILU UNIVERSITY OF TECHNOLOGY, Jinan (CN)

(72) Inventors: Jiaqi XIAO, Jinan (CN); Feng GAO, Jinan (CN)

(21) Appl. No.: 16/600,514

(22) Filed: Oct. 13, 2019

(30) Foreign Application Priority Data
Dec. 21, 2018 (CN) 201811569003.1

(51) Int. Cl. G01V 3/20; G01V 3/34; E21B 49/00; E21B 47/00; E21B 47/14

(52) U.S. Cl. CPC G01V 3/20; G01V 3/34; E21B 47/14; E21B 47/0002; E21B 49/00

(57) ABSTRACT

The present invention belongs to the technical field of geophysical logging in mines, and particularly relates to a formation microscanner tool and a logging method using the same. The present invention provides a three-dimensional formation microscanner tool, comprising: multiple button sonde pads each having a large number of button electrodes that are insulated from each other and may be arranged in one or more rows surrounding the borehole and one axial sonde, multiple button sonde pads of a same type being held against the borehole wall and arranged at a same axial depth position or at multiple axial depth positions. Multiple return electrodes in different positions are arranged on the axial sonde, with insulating electrodes interposed between the return electrodes; and by frequency division, the measurement current at different frequencies is enabled to return to different return electrodes through button electrodes on the button sonde pads.

### CROSS-REFERENCE TO RELATED APPLICATIONS

This application claims the benefit of priority from Chinese Patent Application No. CN 201811569003.1, filed on Dec. 21, 2018. The content of the aforementioned application, including any intervening amendments thereto, is incorporated herein by reference in its entirety.

### TECHNICAL FIELD

The present invention belongs to the technical field of geophysical logging in mines, and relates to the microresistivity logging technique and in particular to a formation microscanner tool and a logging method using the same.

### BACKGROUND OF THE PRESENT INVENTION

Geophysical logging in mines, regarded as the underground “eye”, measures the lithology, physical properties, permeability and oil-bearing reservoirs of the downhole formation in various physical methods. With the development of science and technology, the development of logging has experienced analog log, digital log and imaging log. Now, it is in the development stage of multi-dimensional log, including three-dimensional induction log, three-dimensional laterolog and three-dimensional nuclear magnetic resonance log, etc.

The microresistivity logging tool measures the formation resistivity of areas near the borehole wall by being held against the borehole wall, and measures the variation of resistivity in areas near the borehole wall with high resolution. As the tool moves in the borehole axis (depth), the measurement result is a one-dimensional logging curve. On the basis of microresistivity logging, by expanding the structure of the measuring electrodes, a large number of button electrodes are arranged surrounding the borehole. A formation microimager is developed, which, as the tool moves in the borehole axis (depth) direction, measures the variation of resistivity in the borehole axis (depth) direction and surrounding the borehole in areas near the borehole. The measurement result is two-dimensional data which is processed, by imaging, to form a two-dimensional image that is similar to the core profile.

As a typical contact imaging instrument, the formation microimager utilizes multiple pads, for example, four pads, six pads or eight pads, with button electrodes arranged on each pad in rows. The pads emit current to the formation. Due to different resistivity of rock portions contacted by the button electrodes, the current flowing through the button electrodes is different, which respectively reflects the resistivity at the contacted borehole wall. The current intensity at each button electrode and the corresponding measured potential difference are recorded, and converted into a microresistivity curve. Numerous button electrodes correspond to numerous microresistivity curves. These microresistivity curves are processed by imaging and displayed as an image.

The formation microimager changes the one-dimensional microresistivity log to two-dimensional microresistivity log by a large number of button electrodes which are arranged, surrounding the borehole, on the borehole wall contact pads. However, with the development of technology, due to the wide use of highly deviated wells and horizontal wells and the increase in reservoir complexity, it becomes very urgent to investigate three-dimensional variations in the formation surrounding the borehole.

In addition, a quasi-stationary state field between the pads and the return electrodes in the formation microimager is formed near the borehole wall. Its distribution pattern is directly related to the radial investigation depth and resolution of the microresistivity measurement by the button electrodes. The radial investigation depth and the resolution are in a trade-off relationship. Since the result of formation microimaging is quite sensitive to the contact of the pads against the borehole wall, to ensure that the pads are tightly held against the borehole wall, the stress of pushing the pads toward the borehole wallis generally increased. However, too high pushing stress will increase the resistance to the movement of the tool. As a result, the tool is unable to move continuously and smoothly. Thus, a “stop-jump-stop-jump” motion pattern occurs. Accordingly, the imaging quality is affected severely. It is a difficulty, during the use of the conventional formation microimager, to tightly hold the pads against the borehole wall and also ensure that the tool can move continuously and smoothly. In the case of shallow radial investigation, the imaging resolution will be high, but the pads are required to be appropriately held against the borehole wall, otherwise the small convex-concave gaps between the pads and the borehole wall will produce a false change in imaging; and in the case of deep radial investigation, the imaging result is less sensitive to the small convex-concave gaps between the pads and the borehole wall, but the imaging resolution also decreases. It is desired to ensure high resolution in large investigation depth. It is a challenge, in the design of formation microimagers, to ensure high resolution in large investigation depth. During the practical logging, due to great formation variations, the environment of the borehole wall changes as the formation lithology, formation construction and drilling processes change. It is very important to design a formation microimager that is adaptable to varying borehole wall environments.

### SUMMARY OF THE PRESENT INVENTION

The present invention provides a three-dimensional formation microscanner tool that measures the variation of resistivity near the borehole wall in the borehole axis (depth) direction, surrounding the borehole and in the radius direction. The measurement result is three-dimensional data which is processed to form a three-dimensional image by virtual reality imaging, or to extract many two-dimensional tomographic images by slicing in any direction. The two-dimensional images extracted by slicing in the radius direction have the same properties as images obtained by the conventional formation microscanners.

To solve the technical problems, the following technical solutions are used in the present invention. A three-dimensional formation microscanner tool is provided, comprising: multiple button sonde pads each having a large number of button electrodes that are insulated from each other and may be arranged in one or more rows surrounding the borehole and one axial sonde, multiple button sonde pads of a same type being held against the borehole wall and arranged at a same axial depth position or at multiple axial depth positions, wherein multiple return electrodes in different positions are arranged on the axial sonde, with insulating electrodes interposed between the return electrodes; and by frequency division, the measurement current at different frequencies is enabled to return to different return electrodes through button electrodes on the button sonde pads.

The distance from the buttonsonde pad to the return electrode is called source spacing that controls an investigation depth of the measurement current after leaving the button electrode.

The frequency of the measurement current is collaborative with the source spacing for scanning or tomographic imaging in the investigation depth direction.

A combination of each of the source spacings and each frequency of the measurement current corresponds to one discrete point in the investigation depth direction.

Scanning in the axial depth is done by the movement of the three-dimensional formation microscanner tool, and scanning surrounding the borehole is done by the arrangement of the button electrodes.

A signal processing circuit, which receives, amplifies and processes tool signals, is mounted on the button sonde pad; and a control circuit, which is used for current emission and communication, is mounted on the axial sonde.

The signal processing circuit comprises a current measurement amplifier circuit, a data collection circuit, an analog-to-digital conversion circuit, a digital filter circuit and an operational circuit, which are connected successively, to amplify, digitalize and filter current signals from the button electrodes in the button sonde pads, and to calculate the resistivity.

The control circuit comprises a main control circuit, a current emission circuit, a driving circuit for a scanning arm and a data telemetry circuit; each of the current emission circuit, the driving circuit for a scanning arm and the data telemetry circuit is connected to the main control circuit; and the main control circuit performs serial communication with the operational circuit.

Another technical solution is also used in the present invention. A logging method using a three-dimensional formation microscanner toolis provided, comprising following steps:
(1) generating, by a current emission circuit, current signals at different frequencies, a current signal at each frequency corresponding to a return electrode with a source spacing and being used for driving the return electrode;
(2) simultaneously emitting current signals at different frequencies by return electrodes with a corresponding source spacing; receiving, by each button electrode in button sonde pads, current signals mixed with various frequency components, and sending the received current signals to a signal processing circuit;
(3) amplifying the signals by a current measurement amplifier circuit, collecting the signals by a data collection circuit, digitalizing the collected signals by an analog-to-digital conversion circuit, filtering the digital signals by a filter, analyzing signals at each emission frequency from the collected data, and separately operating the signals at each frequency, to obtain resistivity data at each frequency; and
(4) processing the resistivity data obtained in the step (3), which is three-dimensional resistivity data in the borehole axis direction, surrounding the borehole, and in the radius (investigation depth) direction, to form a three-dimensional image by virtual reality imaging, or to extract many two-dimensional tomographic images by slicing in any direction.

The three-dimensional formation microscanner tool of the present invention measures the variation of resistivity near the borehole wall in the borehole axis (depth) direction, surrounding the borehole and in the radius (investigation depth) direction. The measurement result is three-dimensional data which is processed to form a three-dimensional image by virtual reality imaging, or to extract many two-dimensional tomographic images by slicing in any direction. The three-dimensional data and the three-dimensional images can be used for analysis of the formation microresistivity in three directions, giving rise to new applications in information and geology. The tool and method of the present invention can be used in fracture identification, thin bed analysis, reservoir assessment, permeability assessment, and studies of sedimentary facies and sedimentary structures, with unique advantages in assessment of complex lithology and fractures.

The two-dimensional images, which are obtained by slicing the three-dimensional data obtained by the formation microscanner tool of the present invention in the radius direction, have the same properties as images extracted by the conventional formation microscanners. By comparing the two-dimensional images extracted by slicing in different radius directions, an optimal two-dimensional microresistivity scanning image can be obtained by selection, merging, etc. Thanks to this function, during logging, the stress of holding the pads against the borehole wall may be properly decreased. Thus, the difficulties in ensuring both the imaging quality and the stress of pushing the pads and in ensuring both the radial investigation depth and the imaging resolution can be overcome. Tomographic images with high resolution are used in segments with good borehole conditions, and tomographic images with large investigation depth are used in segments with poor borehole conditions.

### BRIEF DESCRIPTION OF THE DRAWINGS

FIG. 1 is a structure diagram of the three-dimensional formation microscanner tool according to the present invention;

FIG. 2 is a structure diagram of one embodiment of the three-dimensional formation microscanner tool according to the present invention;

FIG. 3 is a circuit diagram of one embodiment of the three-dimensional formation microscanner tool according to the present invention; and

FIG. 4 is a signal processing flowchart of one embodiment of the logging method according to the present invention.

### DETAILED DESCRIPTION OF THE PRESENT INVENTION

The three-dimensional formation microscanner tool according to the present invention will be described and explained below in detail with reference to the accompanying drawings. In this embodiment, the three-dimensional formation microscanner tool according to the present invention will be described in detail by using, as an example, three return electrodes.

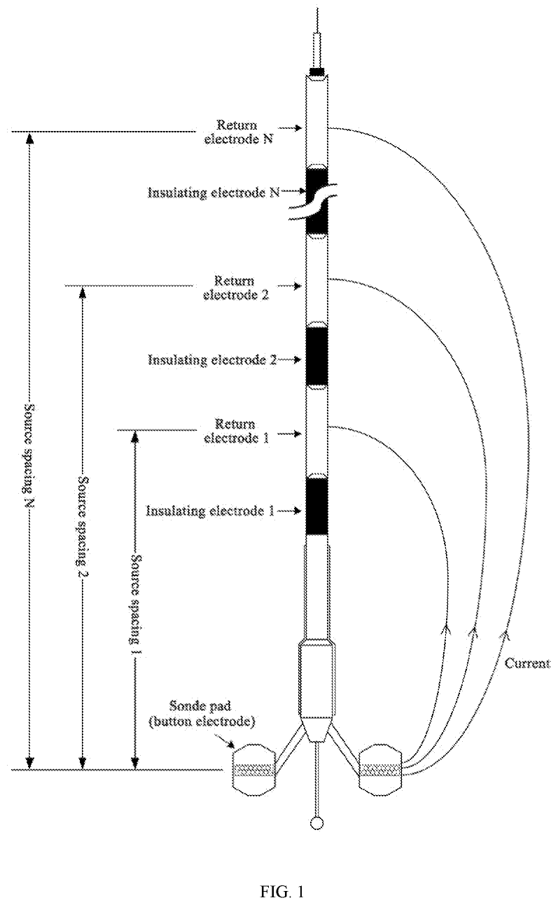

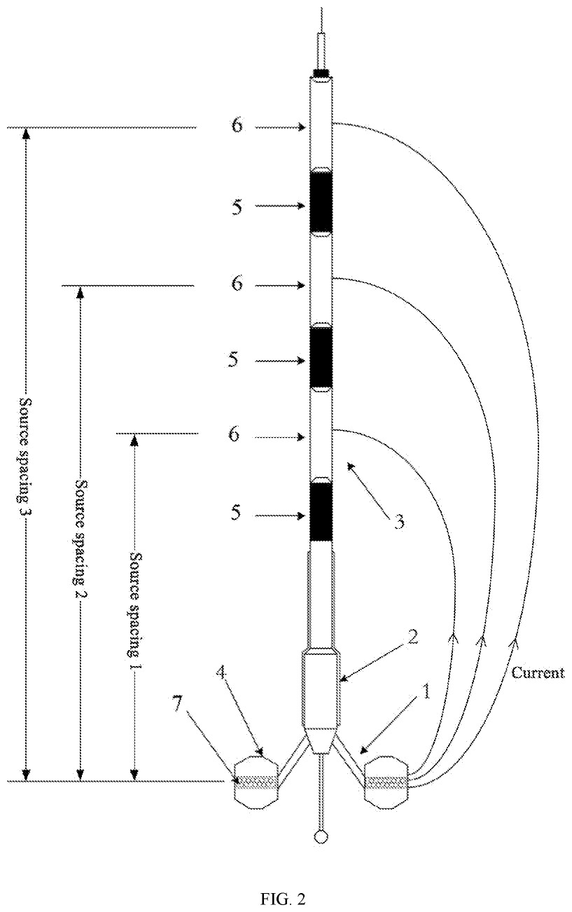

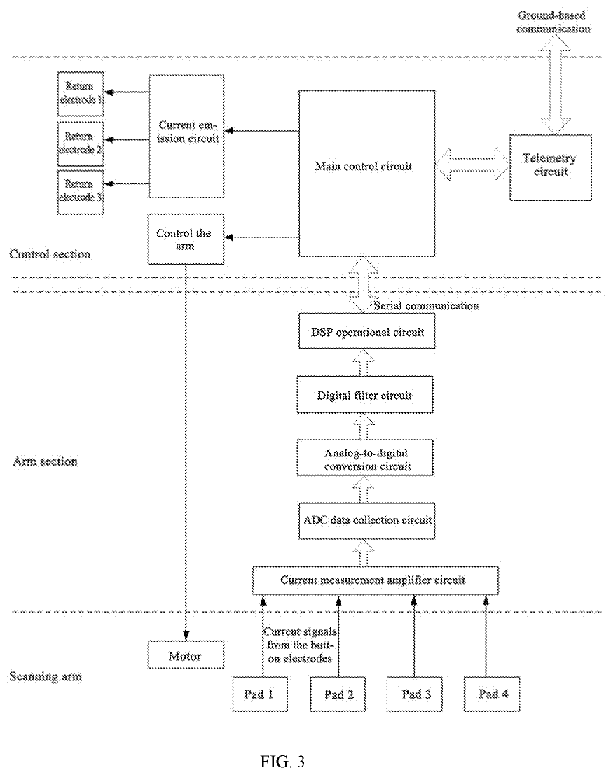

As shown in FIGS. 1 and 2, the three-dimensional formation microscanner tool in this embodiment comprises: successively from the bottom up, a scanning arm 1, an arm section 2 and a control section 3. The scanning arm 1 comprises multiple button sonde pads 4 and a driving circuit that pushes the button sonde pads toward the borehole wall. Each button sonde pad 4 has a large number of button electrodes 7 that are insulated from each other and arranged in one or more rows surrounding the borehole. Multiple button sonde pads 4 of a same type are held against the borehole wall and may be arranged at a same axial (depth) position or at multiple axial (depth) positions, in order to provide a coverage, as large as possible, of the borehole wall by the button electrodes 7 surrounding the borehole, to ensure the coverage of the borehole axis. As shown in FIGS. 2 and 3, the arm section 2 comprises a signal processing circuit and a housing, and is configured to amplify, digitalize and digitally filter current signals from the button electrodes 7 in the button sonde pads 4, and to calculate the resistivity at each frequency after the digital filtering. The signal processing circuit comprises a current measurement amplifier circuit, a data collection circuit, an analog-to-digital conversion circuit, a digital filter circuit and an operational circuit. The control section 3 comprises an axial sonde and a control circuit. The axial sonde comprises three return electrodes 6 and three insulating electrodes 5. The three return electrodes 6 at different positions are arranged with insulating electrodes 5 interposed between them.

The control circuit has following main functions: the three return electrodes emit current signals, control the push-driving of the scanning arm, receive the processed resistivity data from the arm section, and perform data transmission with the ground-based systems. Furthermore, the control circuit comprises a main control circuit, a current emission circuit, a push-driving circuit for the scanning arm and a data telemetry circuit. The control circuit collects the desired data in real time, controls the power of the current emission circuit to ensure that the tool operates in the normal range, and realizes the control on the pushing of the scanning arm so that the tool can move smoothly in the axial direction while being held against the borehole wall. The insulating electrodes are configured to realize the isolation of the button sonde pads from the return electrodes, and also the isolation between the return electrodes, in order to ensure that the emitted current can flow back to the return electrodes through the formation. The data telemetry circuit is configured to implement data transmission between downhole instruments and ground-based instruments.

The distance from the buttonsonde pad to the return electrode is called source spacing that, as a major factor, controls a depth for the measurement current into the formation radius after leaving the button electrode, referred to as investigation depth. The frequency of the measurement current also affects, as a secondary factor, the investigation depth. The depth for the current at a high frequency into the formation is small. The frequency of the measurement current is collaborative with the source spacing for scanning or tomographic imaging in the radius (investigation depth) direction. A combination of each of the source spacings and each frequency of the measurement current corresponds to one discrete point in the radius (investigation depth) direction. Due to the use of multiple source spacings and the measurement current at multiple frequencies, the scanning in different radii (investigation depths) is realized. Scanning in the axial direction (depth) is done by the movement of the three-dimensional formation microscanner tool in this embodiment, and scanning against the circumference of the borehole wall is done by the arrangement of the button electrodes.

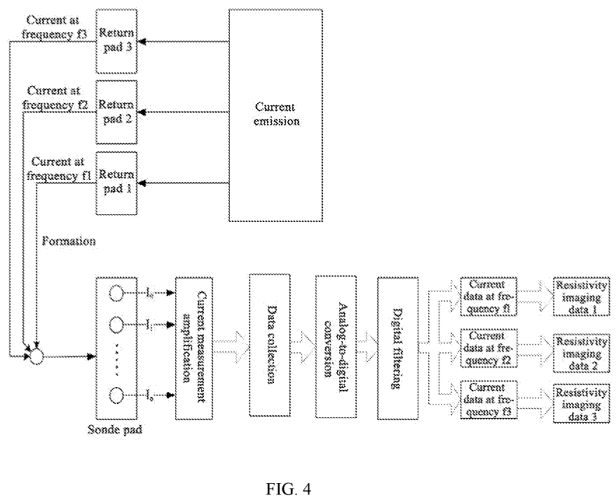

The working principle and signal processing flows of the three-dimensional formation microscanner tool in this embodiment are shown in FIG. 4. Specifically, the current emission circuit generates three current signals at different frequencies f1, f2 and f3. The three signals drive three return electrodes with different source spacings, respectively. The three current signals at different frequencies are simultaneously sent by three return electrodes. Each button electrode in the button sonde pads receives the current signals mixed with various frequency components in the formation, and sends the received current signals to the signal processing circuit. The signals are amplified by the current measurement amplifier circuit, the signals are collected by the data collection circuit, the collected signals are digitalized by the analog-to-digital conversion circuit, the digital signals are filtered by the filter, signals at each emission frequency are analyzed from the collected data, and the signals at each frequency are separately operated, to obtain resistivity data at each frequency.

The resistivity data at different frequencies is three-dimensional resistivity data in the borehole axis (depth) direction, surrounding the borehole, and in the radius (investigation depth) direction. The resistivity data is processed to form a three-dimensional image by virtual reality imaging, or to extract many two-dimensional tomographic images by slicing in any direction. The two-dimensional images extracted by slicing in the radius direction have the same properties as images obtained by the conventional formation microscanners.

A combination of each of the source spacings and each frequency of the measurement current corresponds to one discrete point in the radius (investigation depth) direction. Due to the use of multiple source spacings and the measurement current at multiple frequencies, the scanning in different radii (investigation depths) is realized.

Signal filtering may be performed before signal collection. The signals are filtered to obtain received analog signals at different emission frequencies; and then, data is collected from the analog signals at each frequency and processed to obtain the resistivity data at different frequencies.

The three-dimensional data and the three-dimensional images, which are obtained by the three-dimensional formation microscanner tool and the logging method according to the present invention, can be used for analysis of the formation microresistivity in three directions, giving rise to new applications in information and geology. The tool and method of the present invention can be used in fracture identification, thin bed analysis, reservoir assessment, permeability assessment, and studies of sedimentary facies and sedimentary structures, with unique advantages in assessment of complex lithology and fractures.

What is claimed is:

1. A three-dimensional formation microscanner tool, comprising: multiple button sonde pads each having a large number of button electrodes that are insulated from each other and arranged in one or more rows surrounding the borehole and one axial sonde, multiple button sonde pads of a same type being held against the borehole wall and arranged at a same axial depth position or at multiple axial depth positions, wherein multiple return electrodes in different positions are arranged on the axial sonde, with insulating electrodes interposed between the return electrodes; and by frequency division, the measurement current at different frequencies is enabled to return to different return electrodes through button electrodes on the button sonde pads.

2. The three-dimensional formation microscanner tool according to claim 1, wherein the distance from the buttonsonde pad to the return electrode is called source spacing that controls an investigation depth of the measurement current after leaving the button electrode, the investigation depth being a depth for the measurement current into the formation radius.

3. The three-dimensional formation microscanner tool according to claim 2, wherein the frequency of the measurement current is collaborative with the source spacing for scanning or tomographic imaging in the investigation depth direction.

4. The three-dimensional formation microscanner tool according to claim 3, wherein a combination of each of the source spacings and each frequency of the measurement current corresponds to one discrete point in the investigation depth direction.

5. The three-dimensional formation microscanner tool according to claim 1, wherein scanning in the axial depth is done by the movement of the three-dimensional formation microscanner tool, and scanning surrounding the borehole is done by the arrangement of the button electrodes.

6. The three-dimensional formation microscanner tool according to claim 1, wherein a signal processing circuit, which receives, amplifies and processes tool signals, is mounted on the button sonde pad; and a control circuit, which is used for current emission and communication, is mounted on the axial sonde.

7. The three-dimensional formation microscanner tool according to claim 2, wherein a signal processing circuit, which receives, amplifies and processes tool signals, is mounted on the button sonde pad; and a control circuit, which is used for current emission and communication, is mounted on the axial sonde.

8. The three-dimensional formation microscanner tool according to claim 3, wherein a signal processing circuit, which receives, amplifies and processes tool signals, is mounted on the button sonde pad; and a control circuit, which is used for current emission and communication, is mounted on the axial sonde.

9. The three-dimensional formation microscanner tool according to claim 4, wherein a signal processing circuit, which receives, amplifies and processes tool signals, is mounted on the button sonde pad; and a control circuit, which is used for current emission and communication, is mounted on the axial sonde.

10. The three-dimensional formation microscanner tool according to claim 6, wherein the signal processing circuit comprises a current measurement amplifier circuit, a data collection circuit, an analog-to-digital conversion circuit, a digital filter circuit and an operational circuit, which are connected successively, to amplify, digitalize and filter current signals from the button electrodes in the button sonde pads, and to calculate the resistivity.

11. The three-dimensional formation microscanner tool according to claim 7, wherein the signal processing circuit comprises a current measurement amplifier circuit, a data collection circuit, an analog-to-digital conversion circuit, a digital filter circuit and an operational circuit, which are connected successively, to amplify, digitalize and filter current signals from the button electrodes in the button sonde pads, and to calculate the resistivity.

12. The three-dimensional formation microscanner tool according to claim 8, wherein the signal processing circuit comprises a current measurement amplifier circuit, a data collection circuit, an analog-to-digital conversion circuit, a digital filter circuit and an operational circuit, which are connected successively, to amplify, digitalize and filter current signals from the button electrodes in the button sonde pads, and to calculate the resistivity.

13. The three-dimensional formation microscanner tool according to claim 9, wherein the signal processing circuit comprises a current measurement amplifier circuit, a data collection circuit, an analog-to-digital conversion circuit, a digital filter circuit and an operational circuit, which are connected successively, to amplify, digitalize and filter current signals from the button electrodes in the button sonde pads, and to calculate the resistivity.

14. The three-dimensional formation microscanner tool according to claim 10, wherein the control circuit comprises a main control circuit, a current emission circuit, a driving circuit for a scanning arm and a data telemetry circuit; each of the current emission circuit, the driving circuit for a scanning arm and the data telemetry circuit is connected to the main control circuit; and the main control circuit performs communication with the operational circuit.

15. The three-dimensional formation microscanner tool according to claim 11, wherein the control circuit comprises a main control circuit, a current emission circuit, a driving circuit for a scanning arm and a data telemetry circuit; each of the current emission circuit, the driving circuit for a scanning arm and the data telemetry circuit is connected to the main control circuit; and the main control circuit performs communication with the operational circuit.

16. The three-dimensional formation microscanner tool according to claim 12, wherein the control circuit comprises a main control circuit, a current emission circuit, a driving circuit for a scanning arm and a data telemetry circuit; each of the current emission circuit, the driving circuit for a scanning arm and the data telemetry circuit is connected to the main control circuit; and the main control circuit performs communication with the operational circuit.

17. The three-dimensional formation microscanner tool according to claim 13, wherein the control circuit comprises a main control circuit, a current emission circuit, a driving circuit for a scanning arm and a data telemetry circuit; each of the current emission circuit, the driving circuit for a scanning arm and the data telemetry circuit is connected to the main control circuit; and the main control circuit performs communication with the operational circuit.

18. A logging method using a three-dimensional formation microscanner tool, comprising following steps:
(1) generating, by a current emission circuit, current signals at different frequencies, a current signal at each frequency corresponding to a return electrode with a source spacing and being used for driving the return electrode;
(2) simultaneously emitting current signals at different frequencies by return electrodes with a corresponding source spacing; receiving, by each button electrode in button sonde pads, current signals mixed with various frequency components, and sending the received current signals to a signal processing circuit;
(3) amplifying the signals by a current measurement amplifier circuit, collecting the signals by a data collection circuit, digitalizing the collected signals by an analog-to-digital conversion circuit, filtering the digital signals by a filter, analyzing signals at each emission frequency from the collected data, and separately operating the signals at each frequency, to obtain resistivity data at each frequency; and
(4) processing the resistivity data obtained in the step (3), which is three-dimensional resistivity data in the borehole axis direction, surrounding the borehole, and in the radius (investigation depth) direction, to form a three-dimensional image by virtual reality imaging, or to extract many two-dimensional tomographic images by slicing in any direction.
